(19) United States
(12) Patent Application Publication
(10) Pub. No.: US 2006/0064231 A1
(43) Pub. Date: Mar. 23, 2006

(54) Method and apparatus for detemining the rotational speed of turbochargers

(75) Inventors: Nicholas Fekete, Stuttgart (DE); Lorenzo Matassini, Filderstadt (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/068,847

(22) Filed: Mar. 2, 2005

(30) Foreign Application Priority Data
Mar. 3, 2004 (DE) 10 2004 010 263.5

(51) Int. Cl. G06F 19/00; F02D 23/00

(52) U.S. Cl. 701/114; 60/602

(57) ABSTRACT

The invention relates to a method and a corresponding apparatus for detecting the rotational speed of turbochargers, especially on internal combustion engines in motor vehicles, with the steps: recording the body sound (S_{E}) of the turbocharger and analyzing the frequency spectrum (30, 31, 32, 33) of the recorded body sound (S_{E}). According to the invention, in the analysis of the frequency spectrum several frequency signals (S_{D1}, S_{D2}, S_{D3}) are determined, which represent possible rotational speeds of the turbocharger, an amplitude analysis of the recorded body sound (S_{E}) is performed in order to determine an estimated value (S_{D-estimate}) for the turbocharger speed, and the estimated value (S_{D-estimate}) is correlated with the several frequency signals (S_{D1}, S_{D2}, S_{D3}) in order to determine the frequency signal (S_{D2}) as the actual turbocharger rotational speed (D_{actual}) which correlates with the greatest probability with the obtained estimate (S_{D-estimate}).

### BACKGROUND AND SUMMARY OF THE INVENTION

This application claims the priority of German Patent Application No. 10 2004 010 263.5, filed Mar. 3, 2004, the disclosure of which is expressly incorporated by reference herein.

The invention relates to a method for determining the rotational speed of turbochargers, especially on internal combustion engines in motor vehicles.

A simple and reliable determination of turbocharger speed under all operating conditions, which is determined by the load and the rotational speed, is the basic requirement for the efficient operation of a modern internal combustion engine with turbocharger. The detected rotational speed can then be used as a control factor for the regulation of the turbocharger and its entire characteristic in the turbocharger operation of the motor. On the basis of the detection of the rotational speed it is possible to operate the turbocharger at its maximum speed limit and prevent possible destruction from overspeeding. Controlling interventions in the entire motor control are thereby made possible.

Conventional systems for detecting turbocharger speed are based on optical and inductive methods which require considerable expense in their implementation. Thus, for example, the turbocharger buckets or added-on impeller wheels on the turbocharger shaft are sensed photoelectrically or inductively and evaluated in a high-quality evaluation electronic device connected to its output.

WO 94/17420 A1 disclosed the use of a microphone for detecting the rotational speed of turbochargers. The sound picked up by this microphone is processed through corresponding filters and then evaluated to determine the turbocharger's speed. Such microphones, however, are poorly suited to mass production, and problems also exist regarding their stability and lifetime.

Also, in DE 40 11 938 A1 a knock sensor is described for detecting waves of vibration in an internal combustion engine, but it is used only for the detection and control of engine knock.

Through U.S. Pat. No. 4,864,859 it is known to apply acceleration detectors on the cases of turbochargers. This known arrangement, however, does not serve for rotational speed detection but for the detection and elimination of imbalance in the rotating system.

It is known through DD 257 126 A1 and DD 269 683 A1 to apply piezoelectrical acceleration detectors to the casing of rotating machines in order thus to determine rotational speed. For the expansion of the signal detected and processed in the acceleration detector, the frequency-amplitude spectrum of the signal is determined in a following signal analyzer, and the speed is determined from speed related resonances, from the highest peaks that occur, and by mathematical conversion.

In DE 198 18 124 C2 an apparatus for detecting the rotational speed of turbochargers on internal combustion engines, which comprises at least one piezoelectrical acceleration detector affixed to the turbocharger and configured as a knock sensor, plus an evaluation circuit. The signal detected by the acceleration pickup is proportional to the acceleration measured on the case of the turbocharger and that is in turn proportional to the imbalance produced by the rotating turbocharger's shaft. Since these imbalance signals occur synchronously with the rotation, the signal detected by the acceleration pickup is proportional to the rotational speed, with noise pulsations and other influences, of course, superimposed. The interfering parts of the measurement signals from the acceleration pickup are filtered out in the evaluating unit, with a band pass filter, for example, so that the useful signal is boosted definitely above the rest of the signal. This useful signal represents the first supercharger order, that is, the rotational speed of the turbocharger shaft. The output signals from the filter system are made available through a frequency-to-voltage converter in the form of an analog voltage or directly in the form of frequency signals as input signals to an electronic controller of the internal combustion engine or to a measuring and display apparatus,

In the process described it is of course possible for the base frequency, or its harmonics formed by the buckets in the turbocharger, to be dominant. To determine the correct turbocharger speed, these transient effects must be compensated.

The object of the invention is to provide a suitable method for detecting the rotational speed of turbochargers, which will compensate the above-described transient effects and make available a corresponding apparatus suitable for mass production for detecting the speed of turbochargers.

The invention achieves this object by providing a method for the detection of the rotational speed of turbochargers, especially on internal combustion engines of motor vehicles, and by an apparatus for rotational speed detection.

The main idea of the invention is to perform an amplitude analysis in addition to the analysis of the frequency spectrum of the recorded body sound of the turbocharger, and with it to determine a rough estimation of the turbocharger's rotational speed. The estimated figure obtained is then correlated with a number of frequency signals obtained by the analysis of the frequency spectrum and representing the possible speeds of the turbocharger. As the actual turbocharger speed, the frequency signal is determined which correlates, with the greatest probability, with the estimated value obtained.

By way of the estimated value of the time-related amplitude analysis proportional to the turbocharger speed, which does not have the transient effects, a simple compensation of the transient effects can be made available. Inasmuch as an amplitude analysis alone is too imprecise for determining the turbocharger speed, in order to be able to operate the turbocharger at its maximum speed limit, it is advantageously combined with the analysis of the frequency spectrum, for the purpose of determining one of the several frequency signals detected in the analysis of the frequency spectrum, which correlates most probably with the imprecise turbocharger speed obtained. Since the frequency signals, which represent possible turbocharger speeds, can be determined with very good accuracy, the actual turbocharger speed can likewise be determined with this high accuracy. The method of the invention is therefore optimally suited for operating the turbocharger at its maximum speed limit. Therefore, excess speeds which can lead to the destruction of the turbocharger are no longer a problem and lower-cost, smaller turbochargers can be used. Also, the regulation of the internal combustion engine can be improved by the knowledge of the precise turbocharger speed, so that the weak starting of vehicles is reduced, better adaptation to altitude is obtained and the overall efficiency of the internal combustion engine in everyday driving can be improved.

In the embodiment of the method of the invention, high-energy frequency signals are preferred in the analysis of the frequency spectrum, while at least one fast Fourier transform is performed.

The frequency signals preferred in the analysis of the frequency spectrum comprise, for example, a fundamental frequency and corresponding high-order harmonics. The dominant harmonics that develop are dependent upon the structural configuration of the turbocharger, for example on the number of buckets present. If the turbocharger has, for example, three buckets, then the harmonics of the third, sixth, ninth, twelfth, etc. order are dominant.

In further embodiment of the method of the invention, a calculation of the variance of the signal amplitudes is performed in the amplitude analysis, in which a quadratic deviation from a mean value is calculated within a small window.

The estimated value obtained gives the turbocharger rotational speed with a tolerance range, for example, of ±10% to ±30%. The frequency signal representing the possible turbocharger speed gives the turbocharger speed, for example, with a tolerance of ±1%.

An apparatus according to the invention for rotational speed detection in turbochargers on internal combustion engines comprises an evaluation circuit with the following elements: means for analyzing the frequency spectrum of the output signal of a sound pickup, in which several frequency signals are obtainable, representing possible rotational speeds of the turbocharger, means for analyzing the amplitude of the output signal of the sound pickup, which determine an estimated value for the turbocharger rotational speed, and means for the correlation of the estimated value with the several frequency signals to determine the actual turbocharger speed, while the frequency signal can be determined from the obtained frequency signals as the actual speed, which correlates, with the greatest probability, with the estimated value.

The apparatus of the invention has the important advantage that the kind of construction of the turbocharger plays no part in the rotational speed detection, while the sound pickup can also be applied to the turbocharger even afterward in a simple manner without the need for the turbocharger to be opened or redesigned. Also, the turbocharger speed can be detected in a very simple and inexpensive manner. In conjunction with an achieved sturdy construction with easy assembly, this apparatus is thus suitable for a mass production at reasonable cost, and for operation in the motor vehicle, and measurements of turbocharger's rotational speeds can be performed also in a simple and cost-effective manner.

In the embodiment of the apparatus for detecting the rotational speed of turbochargers, the means for frequency spectrum analysis comprise means for performing a fast Fourier transform (FFT).

In an especially advantageous embodiment, the at least one sound pickup is a piezo-electronic knock sensor. This means that commercial knock sensors, which have been developed as low-cost mass produced products for knock control in internal combustion engines, can be used for detecting rotational speeds in turbochargers.

In further embodiment of the apparatus for rotational speed detection the at least one sound pickup is arranged on the compressor housing of the turbocharger, since the vibration signals are clearest on the compressor housing and the best conditions are provided for mechanical fastening.

In further embodiment of the device for rotational speed detection, for the synchronization of a turbocharger array (e.g., Bi-Turbo) including two turbochargers on an internal combustion engine, each of these turbochargers is advantageously connected to a sound pickup and a corresponding evaluation circuit. Means are provided in the evaluation circuit or in the electronic control apparatus for forming a differential rotational speed signal or a difference voltage by which this synchronization can be carried out.

Examples of the embodiment of the invention are represented in the drawing and further explained in the description that follows.

### BRIEF DESCRIPTION OF THE DRAWINGS

FIG. 1 is a block circuit diagram of an apparatus for detecting the rotational speed of a turbocharger.

FIG. 2 a schematic representation of the output signal from a sound pickup from FIG. 1 before a frequency and amplitude analysis.

FIG. 3 a schematic representation of the frequency spectrum of the output signal of the sound pickup from FIG. 1.

FIG. 4 a schematic representation of high-energy frequency signals obtained in the frequency analysis.

FIG. 5 a schematic representation of the frequency signal from FIG. 3, correlated with an estimated value obtained by the amplitude analysis.

### DETAILED DESCRIPTION OF THE DRAWINGS

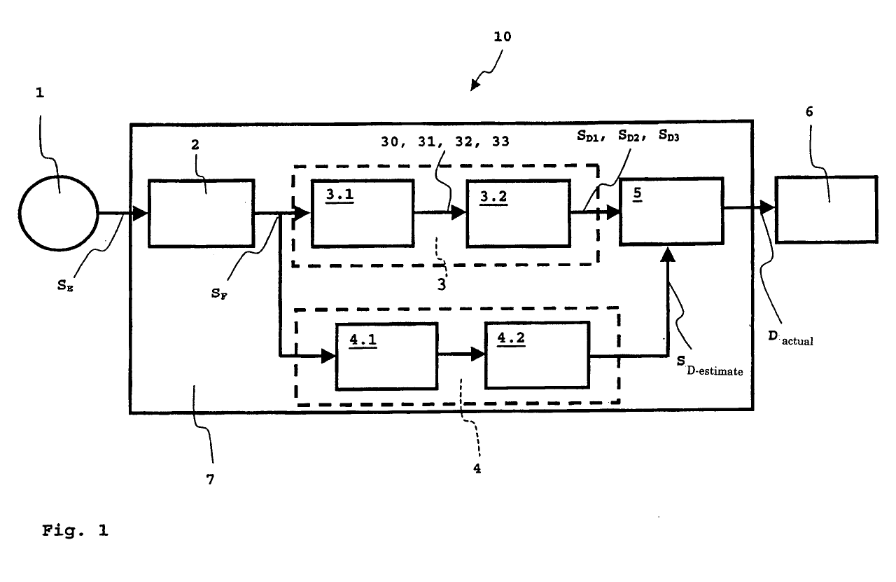

As seen in FIG. 1, the apparatus for rotational speed detection 10 of a turbocharger, not shown, especially one configured as a commercially common piezoelectrical knock sensor 1 which is disposed on the housing of this turbocharger, for example on the compressor housing. The body sound signal S_{E} is proportional to the imbalance produced by the revolving turbocharger shaft. Since these imbalance signals are synchronous with rotation, the signal S_{E} detected by the sound pickup 1 is proportional to the rotational speed of the turbocharger, superimposed, of course, by noise impulses and other influences.

For the evaluation and processing of the signal S_{E} an evaluation unit 7 is connected to it. The output signal D_{actual} of the evaluation unit 7 is fed to an electronic control apparatus 6 to control functions of an internal combustion engine not shown, for example in the form of an analog signal. Such a control apparatus 6 serves in a usual manner, for example, for the control of fuel delivery and/or ignition and/or transmission control or the like. In the present case the turbocharger is also controlled, for example by a bucket adjustment and/or by controlling a waste gate.

To evaluate and process the signal S₂ the evaluation unit 7 includes a first filter 2, which is in the form of an anti-aliasing low-pass filter, for example, means for frequency spectrum analysis 3, means for amplitude analysis 4, and correlation means 5.

The means for frequency spectrum analysis 3 comprise a block 3.1 to receive the frequency spectrum of the filtered signal S_{F} and to perform at least one fast Fourier transform. At the output of block 3.1 several frequency signals, 30, 31, 32, 33, are available which represent possible turbocharger rotational speeds. In the block 3.2 shown, additional calculations are performed for the analysis of the frequency spectrum, such as calculating local averages, energy content, normalization, etc. At the output from this block 3.2 the most energy-rich frequency signals S_{D1}, S_{D2}, S_{D3} of the frequency signals 30, 31, 32, 33 which represent possible rotational speeds of the turbocharger, and whose tolerance is ±1%, are made available to the correlation means 5.

The means for performing the amplitude analysis 4 include a block for receiving the amplitude 4.1 and a block 4.2 in which a rough estimate Sₑₛₜᵢₘₐₜₑ is obtained for the actual turbocharger speed, which has a tolerance of ±10% to ±20%. To determine the estimate Sₑₛₜᵢₘₐₜₑ a computation of the variance of the signal amplitude, for example, can be performed, in which the quadratic deviation from the average is computed within a small window. The estimate Sₑₛₜᵢₘₐₜₑ is put out to the correlation means 5 for further processing.

The correlation means 5 compare the estimate Sₑₛₜᵢₘₐₜₑ with the several frequency signals S_{D1}, S_{D2}, S_{D3} and determine the actual turbocharger speed D_{actual} in which the frequency S_{D2} is determined as the actual turbocharger rotational speed D_{actual} which with the greatest probability correlates with the determined estimated value Sₑₛₜᵢₘₐₜₑ, i.e., the frequency signal is determined which lies within the considered period of time in the range of tolerance of the determined estimate Sₑₛₜᵢₘₐₜₑ.

The apparatus according to the invention for detecting rotational speed 10 can also be used just for measuring rotational speed in the laboratory or on the motor vehicle. In this case the evaluation circuit is not connected to the electronic control device 6 but to a measuring and/or display device in order to determine and display the rotational speed.

If an internal combustion engine is provided with two turbochargers (Bi-Turbo), a sound pickup 1 or knock sensor is applied to each turbocharger, each provided with a corresponding evaluation circuit 7. Thus the possibility exists for the synchronization of these two turbochargers; for this purpose a difference voltage signal is formed from the output signals proportional to the rotational speed.

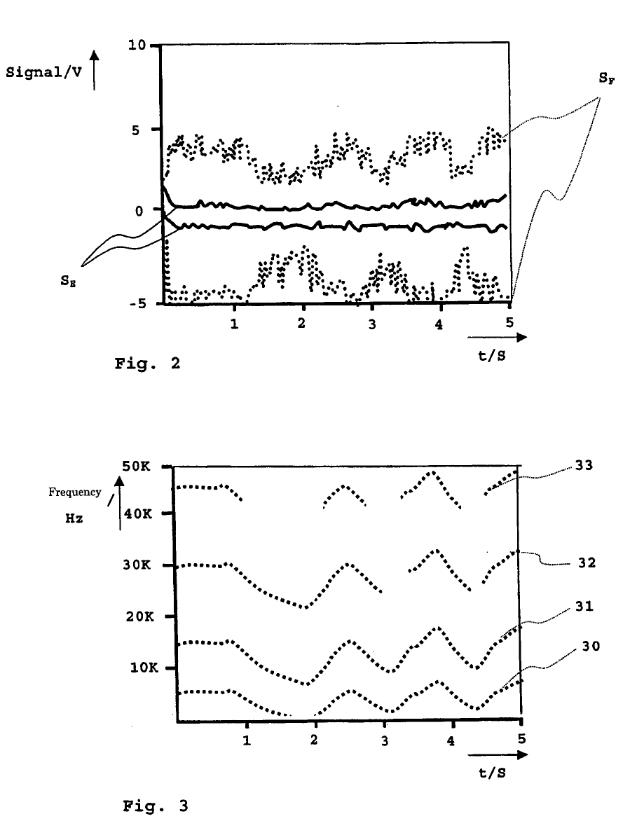

FIG. 2 shows a schematic representation of the output signal from the sound pickup 1 from FIG. 1, before and after the first filter unit 2. The output signal of the sound pickup is marked S_{E} and the output signal of the first filter unit 2 is marked S_{F} and shown in broken lines. Both signals S_{E} and S_{F} are represented as envelope curves.

FIG. 3 shows a schematic representation of the frequency spectrum, recorded by block 3.1, of the filtered output signal S_{F} of the sound pickup 1. The frequency signals 30, 31, 32, 33 each represent one possible turbocharger speed and are obtained, for example, by a number of fast Fourier transforms.

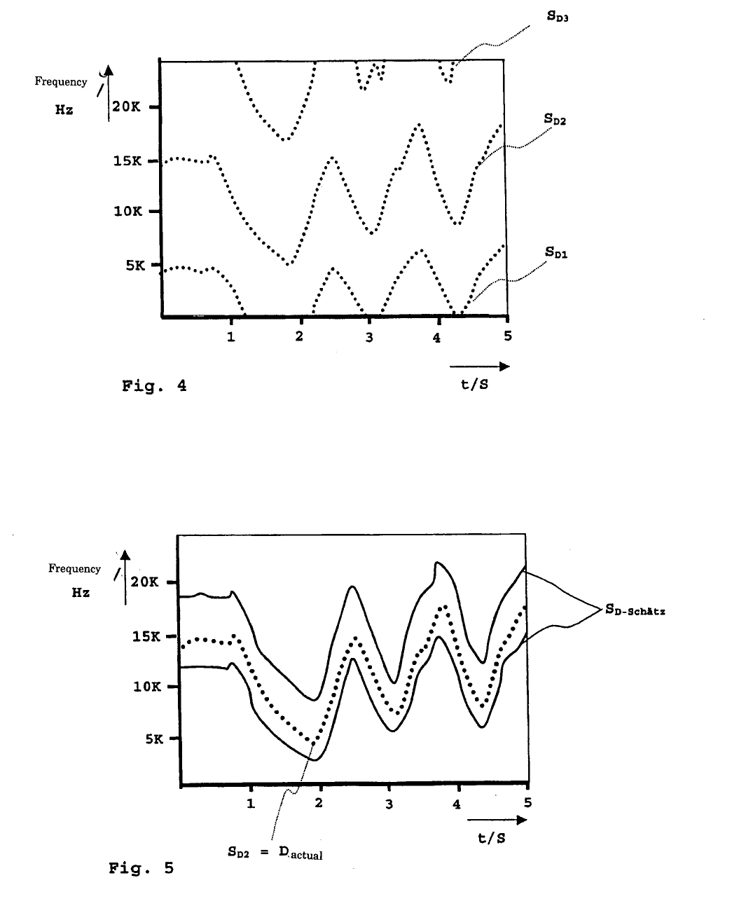

FIG. 4 shows a schematic representation of energy-rich frequency signals S_{D1}, S_{D2,}, S_{D3}. The dominant frequency signals S_{D1}, S_{D2,}, S_{D3} include for example a fundamental frequency S_{D1} and corresponding higher-order harmonics S_{D2,}, S_{D3}. The dominant harmonics are dependent upon the structural design of the turbocharger—for example on the number of buckets present. In the embodiment represented the turbocharger has, for example, three buckets; therefore in addition to the fundamental frequency S_{D1} the harmonics S_{D2,}, S_{D3} of the third and sixth order are dominant. To obtain the represented frequency signals S_{D1}, S_{D2,}, S_{D3} additional computations are performed in block 3.2 for the analysis of the frequency spectrum.

FIG. 5 shows a schematic representation of the estimate Sₑₛₜᵢₘₐₜₑ obtained, with correlated frequency signal S_{D2}. The estimate value Sₑₛₜᵢₘₐₜₑ is represented as a tolerance range in which the correlating frequency signal S_{D2} is situated.

For better comprehension it is now assumed that the actual turbocharger speed is, for example, 15 KHz. Then the means for amplitude analysis 4 obtain an estimated value Sₑₛₜᵢₘₐₜₑ which is put out as a tolerance range of 10.5 Khz (−30%) to 19.5 KHz (+30%) and 13.5 KHz (−10%) to 16.5 KHz (+10%). The means for frequency spectrum analysis 3 give to the correlation means 5, as energy-rich frequency signals, the signal S_{D1} with a frequency of 5 KHz +1% (4.95 to 5.05 KHz), the signal S_{D2} with a frequency of 15 KHz +1% (14.85 to 15.15) and the signal S_{D2} with a frequency of 30 KHz +1% (29.7 Khz to 30.3 KHz). In this case the frequency signal S_{D2} with a frequency of 14.85 to 15.15 KHz (at a tolerance of ±30%) or the tolerance range of 13.5 KHz to 16.5 KHz (at a tolerance of ±10%) of the estimated value Sₑₛₜᵢₐₜₑ obtained. This means that the correlation unit 5 determines the frequency signal S_{D2} as the actual turbocharger rotational speed D_{actual} and passes it on to the control apparatus 6.

Through the amplitude analysis of the picked-up body sound of the turbocharger, which is performed in addition to the analysis of the frequency spectrum, a rough estimate of the turbocharger speed is determined according to the invention, and can then be correlated with several frequency signals found in the analysis of the frequency spectrum, in order to obtain the actual turbochrger speed with good accuracy.

Thus, transient effects occurring during the frequency analysis can be easily compensated and the turbocharger can be operated at its maximum rotational speed limit, so that smaller turbochargers can be used. In addition, with the knowledge of the exact turbocharger rotational speed the control of the internal combustion engine can be improved, thereby reducing the starting weakness of motor vehicles, a better adaptation to altitude is obtained and the general efficiency of the internal combustion engine in everyday operation can be improved.

The method of the invention can additionally be used in the laboratory for the planning and design of exhaust turbocharger controls. Also, due to the simple construction of the device, comparative measurements can be performed on the vehicle without intervention into the system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method of detecting rotational speed of a turbocharger, comprising the steps:
recording body sound of the turbocharger;
finding several frequency signals in the analysis of the frequency spectrum of the recorded body sound, which represent possible rotational speeds of the turbocharger;
analyzing amplitudes of the recorded body sound to determine an estimated value for the turbocharger speed;
correlating the estimate obtained with the several frequency signals; and
determining one of the several frequency signals as the actual turbocharger speed, which correlates with the determined estimate.

12. The method according to claim 11, wherein, in the analysis of the frequency spectrum, at least one fast Fourier transform being performed.

13. The method according to claim 12, wherein the frequency signals in the analysis of the frequency spectrum comprise a fundamental frequency and corresponding harmonics of higher order, the order of the occurring harmonics being dependent on the number of buckets in the turbocharger.

14. The method according to claim 13, wherein, in the amplitude analysis, a variance calculation of the signal amplitude is performed.

15. The method according to claim 14, wherein the estimated value gives the actual turbocharger rotational speed with a range of tolerance of ±10% to ±30%, the frequency signal representing a turbocharger rotational speed giving the possible turbocharger speed with a tolerance of ±1%.

16. The method according to claims 11, wherein, in the amplitude analysis, a variance calculation of the signal amplitude is performed.

17. The method according to claim 11, wherein the estimated value gives the actual turbocharger rotational speed with a range of tolerance of ±10% to ±30%, the frequency signal representing a turbocharger rotational speed giving the possible turbocharger speed with a tolerance of ±1%.

18. Apparatus for detecting rotational speed of a turbochargers if an internal combustion engine, comprising:
a sound pickup disposed on the turbocharger;
a device for recording and analyzing a frequency spectrum of output signals of the sound pickup; and
an evaluation circuit that is designed to conduct an frequency spectrum analysis to obtain a plurality of frequency signals which represent possible rotational speeds of the turbocharger, an amplitude analysis to obtain an estimate of the actual turbocharger speed, and a correlation of the obtained estimate with one of the several frequency signals in order to determine the actual turbocharger speed, wherein the frequency signal being determined from the determined frequency signals as the actual speed correlates with the greatest probability with the determined estimate.

19. Apparatus according to claim 18, wherein the frequency spectrum analysis includes performing a fast Fourier transform.

20. Apparatus according to claim 19, wherein the at least one sound pickup includes a piezoelectric knock sensor.

21. Apparatus according to claim 20, wherein the at least one sound pickup is disposed on a compressor case of the turbocharger.

22. Apparatus according to claim 21, wherein, for the synchronization of a turbocharger array having two turbochargers on one internal combustion engine, each of the turbochargers is provided with a sound pickup and a corresponding evaluation circuit.

23. Apparatus according to claim 18, wherein the at least one sound pickup includes a piezoelectric knock sensor.

24. Apparatus according to claim 18, wherein the at least one sound pickup is disposed on a compressor case of the turbocharger.

25. Apparatus according to claim 18, wherein, for the synchronization of a turbocharger array having two turbochargers on one internal combustion engine, each of the turbochargers is provided with a sound pickup and a corresponding evaluation circuit.
